(19) United States
(12) Patent Application Publication
(10) Pub. No.: US 2009/0306861 A1
(43) Pub. Date: Dec. 10, 2009

(54) Method and Control Device for Identifying a Trailer Operation of a Towing Vehicle

(76) Inventors: Andreas Schumann, Tamm (DE); Lars Berding, Seoul/Choong-Ku (KR); Rolf-Hermann Mergenthaler, Leonberg (DE); Daniel Fellke, Stuttgart (DE); Gero Nenninger, Tamm (DE); Michael Brander, Neuenstadt (DE)

Correspondence Address: KENYON & KENYON LLP, ONE BROADWAY, NEW YORK, NY, 10004, US

(21) Appl. No.: 12/227,506

(22) PCT Filed: May 9, 2007
(86) PCT No.: PCT/EP2007/054493

§ 371 Date: Apr. 8, 2009

(30) Foreign Application Priority Data
Jun. 27, 2006 (DE) 10 2006 029 367.3

(51) Int. Cl. B60T 8/1755; B60T 8/17

(52) U.S. Cl. 701/48; 303/123

(57) ABSTRACT

In a method for identifying a trailering mode in the context of a towing vehicle, in particular as part of a vehicle dynamics control system having a trailer roll logic function for stabilizing the combination of towing vehicle and trailer, that identification of the trailering mode is accomplished by a comparison of an actual signal characterizing the vehicle state with a corresponding target signal.

### BACKGROUND OF THE INVENTION

1. Field of the Invention

The present invention relates to a method and a device for identifying whether or not a vehicle is in a trailering mode.

2. Description of Related Art

Published German patent document DE 199 64 048 describes a vehicle dynamics control system having a trailer roll logic function for stabilizing a road vehicle. The towing vehicle is monitored for roll motions; upon identification of a roll motion, the vehicle is automatically decelerated and/or a yaw moment that counteracts the roll motion is impressed.

The known trailer roll logic function is usually activated only when an identification is made as to whether or not a trailer is hitched to the towing vehicle. The existing art contains apparatuses for identifying a trailer, in which apparatuses the signal for identifying a trailering mode is taken from an apparatus that creates a direct connection from the trailer to the towing vehicle. The signal is usually derived by checking the occupancy of a brake-light plug connector and consequently inferring the presence of a trailer.

Published German patent document DE 197 44 066, in particular, describes an apparatus for identifying a trailering mode for a motor vehicle, in which, as a function of the pressure applied to the trailer, a variable characterizing the pressure buildup is ascertained, and a determination is made on the basis of said variable as to whether or not a trailer is attached. The apparatus described in published German patent document DE 197 44 066 presupposes a system having a component for sensing the pressure controlled to the trailer, generally at least a braked trailer. These presuppositions are not always met, with the result that an identification cannot be made for such cases.

In some cases, however, the aforesaid procedures can result in incorrect verifications of the variable representing the presence of the trailer, and thus to incorrect interventions by the vehicle dynamics control system or to suboptimal behavior in terms of vehicle-dynamics, drive-system, and brake-slip regulation and trailer stabilization logic functions. The following cases, for example, can result in incorrect verifications of the variable representing the presence of the trailer:

The apparatus indicating the presence of the trailer is not present or is not being used in the towing vehicle. In countries outside Europe, for example, there is in some cases no obligation to use a brake light plug connector in trailering mode.

The apparatus indicating the presence of the trailer is occupied not by a trailer, but by a different apparatus, for example a bicycle carrier. The vehicle dynamics control system consequently receives the information that the vehicle is being operated with a trailer, even though a trailer is not hitched to the towing vehicle.

### BRIEF SUMMARY OF THE INVENTION

An object of the invention is to provide an improved method for identifying a trailering mode in the context of a towing vehicle, in particular as part of a vehicle dynamics control method, with which method a reliable identification can be made as to whether or not the towing vehicle is in trailering mode. A further object is to provide a corresponding control device for carrying out the method.

The underlying idea of the invention is to infer, based on evaluation of a variable available in any case to a vehicle dynamics control system, whether or not the towing vehicle is in a trailering mode. Based on the result of the evaluation, a trailer logic function and/or a vehicle dynamics control system can be modified, in particular activated, deactivated, sensitized, and/or desensitized. If the existence of a trailering mode is identified, the trailer roll logic function can, for example, be adapted by setting it to be more sensitive. In addition, intervention thresholds can be lowered. Correspondingly, the trailer roll logic function is attenuated, or intervention thresholds are raised and incorrect stimuli are prevented, for the case in which the trailer identification system does not identify a trailer hitched to the towing vehicle. The method according to the present invention can, however, also be used independently of a vehicle dynamics control system and can serve, for example, to output a corresponding signal, in particular to activate a signal lamp in the vehicle cockpit, upon identification of a trailering mode.

Provision is made, according to the present invention, that the method for trailer identification is based on a comparison of an actual signal characterizing the vehicle state and a corresponding target signal. Suitable signals characterizing the vehicle state are, in particular, a yaw rate signal and/or a float angle signal and/or a steering angle signal. Preferably, signals that represent roll motions of the vehicle are evaluated. The corresponding actual signals can be either measured with the aid of at least one sensor, or ascertained or estimated on the basis of other dynamic variables. The corresponding target signal is ascertained on the basis of a reference model having at least one input variable. The reference model is made up, for example, of at least one characteristic curve and/or at least one polynomial. If, for example, the actual yaw rate signal is to be compared to a target yaw rate signal, the target yaw rate signal can then be ascertained based on the Ackermann equation

$${\dot{Ψ}}_{target} = \frac{1}{L} * \frac{v}{1 + {( v / {v}_{ch} )}^{2}} * tan δ$$

in which δ corresponds to the steering angle, v to the vehicle speed (so-called reference speed) ascertained, for example, from the wheel rotation speeds, L to the vehicle's wheelbase, and v_{ch} to the so-called characteristic speed. The characteristic speed is a system parameter that describes the self-steering behavior of the vehicle. Simultaneously, the actual yaw rate is measured via sensors, monitored, and if applicable filtered to various extents.

In an embodiment of the invention, provision is made that identification of the trailering mode of the towing vehicle is effected as a function of identification of a phase shift between the actual signal and the target signal. The invention is based on the recognition that a definite phase shift between an actual signal and a target signal occurs because of the modified vehicle characteristics in trailering mode. The occurrence of such a phase shift is robust with respect to different sizes and embodiments of trailers and of towing vehicle/trailer combinations. The phase shift between target and actual signal can therefore preferably be employed for reliable identification of the trailering mode.

Additionally or alternatively to evaluation of the phase shift between actual signal and target signal, a comparison can be made of the amplitude difference between the actual signal and target signal. In the case of the yaw rate signal in particular, an increase in the amplitude difference between the two signals is produced in trailering mode. If the phase shift and amplitude difference are evaluated cumulatively, this improves the reliability of the trailer identification. In an embodiment of the invention, provision is made with advantage that an exceedance of a limit phase shift is classified as trailering mode. Preferably, the count status of a counter is modified, and/or a marker is set, at each exceedance of a limit phase shift. When a specific count status is reached, the existence of a trailering mode is then identified. Alternatively, it is also conceivable to identify a trailering mode directly upon exceedance of a limit phase shift.

Analogously, provision is made in an embodiment of the invention that an exceedance of a limit amplitude difference is classified as trailering mode. In particular, the count status of a counter is modified, and/or a marker is set, as a function of the exceedance of a limit amplitude difference. This is, in particular, the same counter that is varied upon exceedance of a limit phase shift.

In a refinement of the invention, a trailering mode is identified when the count status that is varied upon exceedance of a limit phase shift and/or a limit amplitude difference reaches, exceeds, or falls below a predefined limit value.

In a refinement of the invention, provision is made with advantage that evaluation of the phase shift is accomplished by evaluating the directional course of the actual signal and of the target signal. In particular, evaluation of the phase shift is accomplished by evaluating the codirectional and/or contradirectional courses of the actual signal and of the target signal.

According to an example embodiment of the invention, the number of cycles in which the actual signal and the target signal move in the same and in the opposite direction is counted. If the actual signal and target signal are moving in the same direction, i.e. both become larger or smaller simultaneously, a counter is then modified (preferably increased) in that cycle. If, on the other hand, the actual signal and target signal are moving in the opposite direction, the counter is modified in the opposite direction (preferably decreased). The increase and decrease in the count status can be accomplished in various ways. Usefully, the change in the count status is accomplished linearly by addition or subtraction of a constant in each cycle, or by multiplication of the count status from the previous cycle by a factor, and a corresponding initialization for the standard value. According to the preferred embodiment, the sign of a product of an actual signal difference and a target signal difference is assessed. The actual signal difference is formed from the actual signal of the current polling cycle and from an actual signal of a previous polling cycle, preferably of the last polling cycle. The target signal difference is formed analogously. The sign indicates whether the actual signal and target signal are moving in the same or in the opposite direction. If they are moving in opposite directions, i.e. if the sign is negative, a phase shift in the current polling cycle is affirmed.

In a refinement of the invention, provision is made with advantage that the count status that represents the number of products having a positive or negative sign is limited to a specific value. If, for example, the count status is increased in the case of a positive sign, and if the maximum count status were not limited, then a very large number of products having a negative sign would need to be counted before the value falls below a predefined limit value and the existence of a trailering mode could be inferred. A trailer would thus be identified in delayed fashion.

It is useful to modify the count status of the aforesaid counter as a function of the result of the evaluation of the amplitude difference between actual signal and target signal. If the amplitude difference exceeds a predefined value, this then indicates the existence of a trailering mode, and the count status is modified in the same direction as in the case of detection of a phase shift or exceedance of a limit phase shift.

The modification of the count status as a function of the amplitude difference can be accomplished, for example, by multiplying the count status by a quotient. The quotient is preferably formed from the amplitude difference that would exist if no trailer were hitched, and from the amplitude difference with a trailer. Depending on the counting direction, the count status can also be formed using a reciprocally formed quotient.

In an embodiment of the invention, provision is made with advantage that the count status is compared with a limit count status. When the count status reaches a limit count status, the existence of a trailering mode is inferred or a trailering mode is identified.

According to an example embodiment of the invention, provision is made that a trailer roll logic function and/or a vehicle dynamics control system is influenced as a function of the identification of a trailering mode or non-trailering mode. For example, a trailer roll logic function can be switched off or desensitized upon identification of a non-trailering mode. Additionally or alternatively, it is possible, when trailering mode has been identified, to activate vehicle stabilization interventions for the purpose of decreasing the instabilities that occur specifically in trailering mode. Furthermore, additionally or alternatively, a deactivation or attenuation of vehicle stabilization interventions can be performed when non-trailering mode has been identified.

In an embodiment of the invention, provision is made with advantage that a modification of the behavior of the vehicle dynamics system is also performed for the case in which the towing vehicle is excited to oscillate independently of a driver stipulation, for example as a result of road surface properties. This can be implemented by the fact that the reference model takes into account, additionally or alternatively to driver stipulations, characterizing input variables such as, for example, the steering angle, [or] corresponding input variables independent of driver stipulation, for example the float angle.

According to an example embodiment of the invention, provision is made that authorization for evaluation of the phase shift between the actual signal and target signal is linked to at least one condition. Preferably, identification of the phase shift remains active for a predefined period of time even after the condition is violated. What can be employed as a condition for activation of the evaluation of the phase shift is, for example, a sufficient modification of the steering angle or exceedance of a threshold of the actual signal, which characterizes the trailer oscillation or the oscillation, caused by the trailer oscillation, of the towing vehicle or of the vehicle combination. If these conditions are met, the evaluation or identification of the phase shift is authorized for a parameterizable period of time, by the fact that identification remains activated while the condition is violated (hysteresis). Upon deactivation of the phase shift evaluation, the variables, for example count statuses or set or unset markers, that are used in the context of identification are usefully reset to an initialization value.

The invention further relates to a control device that is embodied in such a way that it can carry out the aforesaid method. The method is preferably implemented in a control device of a vehicle dynamics control system.

The invention further relates to a method for identifying a phase shift between a first and a second signal. This method is usable in many technical fields, even independently of a method for identifying a trailering mode. According to the present invention, the existence of a phase shift is identified as a function of the sign of a product of a first signal difference and a second signal difference. With regard to more detailed explanations, the reader is referred to the description of this method in this application for the specific instance of trailering mode identification.

### BRIEF DESCRIPTION OF THE SEVERAL VIEWS OF THE DRAWING

FIG. 1 schematically depicts a vehicle dynamics control system.

FIG. 2 is a schematic flow chart of a vehicle dynamics control method.

FIG. 3 shows the execution of a phase shift evaluation.

FIG. 4 shows the signal profile of the actual and target yaw rates in non-trailering mode.

FIG. 5 shows the signal profile of the actual and target yaw rates in trailering mode.

### DETAILED DESCRIPTION OF THE INVENTION

In the Figures, identical components and components having the same function are labeled with the same reference characters.

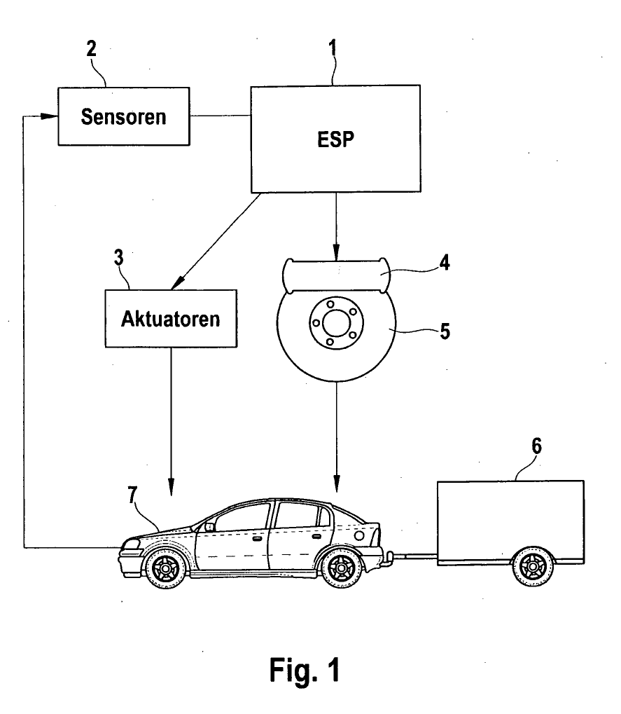

FIG. 1 schematically depicts the system architecture of a complex regulating system that encompasses a vehicle dynamics control system. The vehicle dynamics control system encompasses a control device 1 in which a control algorithm, in the present case an electronic stability program (ESP) and a trailer roll logic function are stored. The vehicle dynamics control system further encompasses a sensor suite 2 for determining the actual behavior, i.e. at least one actual signal, as well as multiple adjusting members 3, 4, 5 such as, for example, an engine control device, a steering positioner, etc., and a wheel brake 5, for influencing the vehicle behavior. Upon exceedance of a predefined intervention threshold, i.e. a predefined system deviation, brake 5, for example, is actuated in order to adapt the yaw behavior of a vehicle 7 to a target value and thus stabilize the vehicle. In trailering mode, i.e. when a trailer 6 is attached, it is conceivable to perform further interventions in order to stabilize vehicle states that occur especially in towing mode, for example trailer rolling.

Implemented in control device 1 is a reference model by way of which a target signal can be ascertained on the basis of at least one input variable, for example the steering angle and/or the vehicle speed. According to the present invention, control device 1 compares the actual signal with the target signal in terms of certain properties, and thus identifies a trailering mode or a non-trailering mode depending on whether certain correlations are satisfied.

The invention will be explained below with reference to a comparison between an actual and a target yaw rate signal. The invention is not limited, however, to the comparison of yaw rate signals. Additionally or alternatively, further features characterizing the roll motions of a vehicle can be utilized in order to assess whether or not a trailering mode exists.

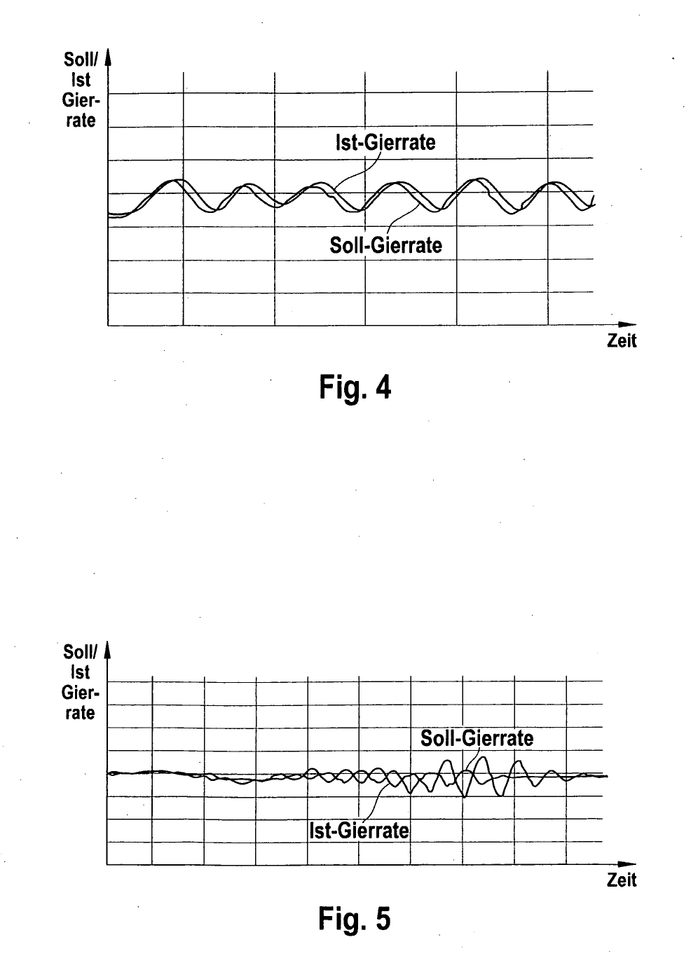

As is evident from a comparison between FIG. 4 (non-trailering mode) and FIG. 5 (trailering mode), a definite phase offset in the region of 90° occurs between the actual and the target yaw rate signal because of the modified vehicle characteristics in trailering mode (cf. FIG. 5). In trailering mode, the actual yaw rate signal leads the target yaw rate signal by approximately 90°.

An increase in the difference in amplitude of the two signals also occurs in trailering mode (cf. FIG. 5). The amplitude difference and the phase shift will be cumulatively utilized below in order to assess whether or not the towing vehicle is in trailering mode. It is also conceivable to employ exclusively the phase shift or exclusively the amplitude difference for such an assessment.

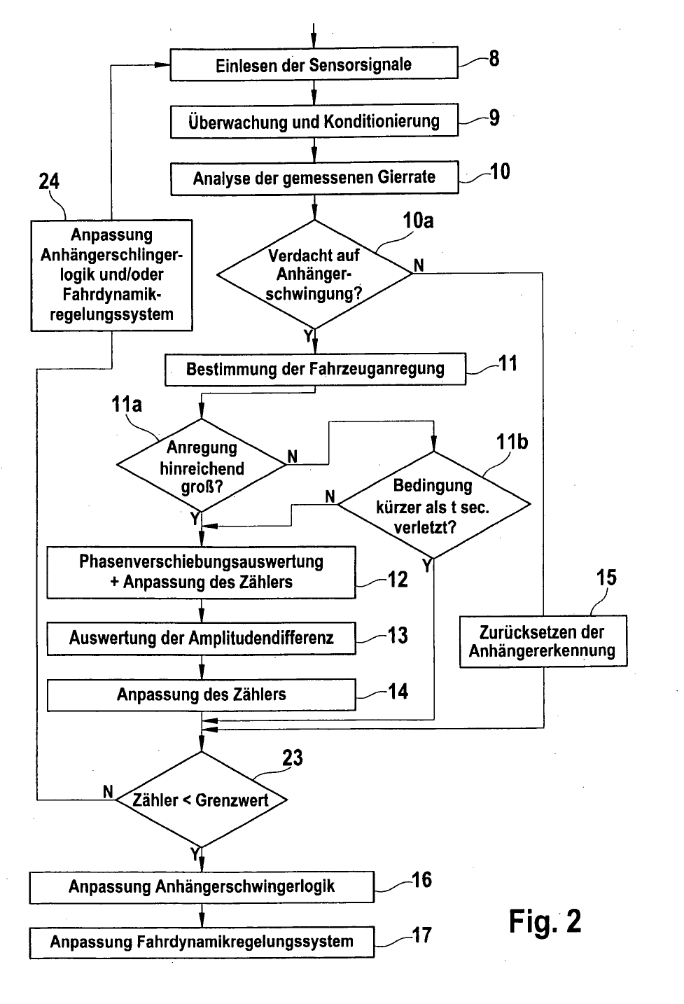

FIG. 2 schematically depicts, in a flow chart, the method sequence in a vehicle dynamics control system with integrated trailer identification. Firstly, in a first method step 8, various sensor signals of the sensor suite are read in, among them the actual yaw rate signal. In a second step 9 subsequent thereto, the signals that have been read in are monitored and conditioned. The signals are therefore filtered and plausibilized. If signals are not plausible, for example certain sensors can be switched off, or their sensitivity modified. Additionally or alternatively, the signal flow can be interrupted.

In a third step subsequent thereto, the plausibilized sensor signals are analyzed, and in step 10a a determination is made as to whether or not a suspicion of trailer roll exists. For example, a check is made as to whether or not a roll behavior of the vehicle can be ascertained at all. If this is not the case, the trailer identification function is reset in step 15. In particular, any markers that were set are set to zero, and count statuses are reset to a starting value.

If the suspicion of a trailer roll exists, then in step 11, on the basis of the actual yaw rate, a variable representing the excitation of the vehicle combination is ascertained, preferably by filtration from the yaw rate signal. A check is then made in step 11a as to whether or not a sufficiently large excitation of the vehicle combination is present, for example by the driver, optionally by a driver assistance system or another system.

If a sufficiently large excitation is not present, execution then continues with step 11b. Step 11b checks how long it has been since the condition for activation of the phase shift identification function has no longer been met. If a predefined time span or a predefined number of cycles, etc. has not yet been exceeded, i.e. if the excitation is too small, the phase shift identification function remains active in accordance with step 12 (hysteresis). Identification is switched off only after the time span has elapsed. Otherwise execution continues with step 23.

If the excitation is sufficiently large, however, for example if the amplitude exceeds a specific value (preferably over several cycles), then in step 11 phase identification is activated and is maintained after the condition for a parameterized time span has lapsed.

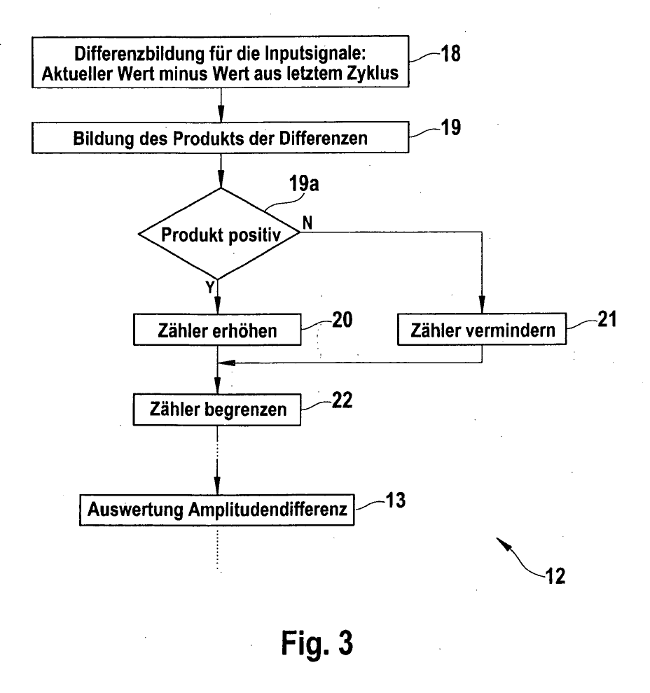

Phase identification according to step 12 is explained in detail in FIG. 3, and will be described in detail later. As a result of the phase shift identification according to step 12, the count status of a counter is increased or lowered.

Evaluation of the amplitude difference between the actual and target yaw rate signals then takes place in step 13. As a result of this evaluation, the counter according to step 12 is adapted in step 14. For example, the count status from step 12 is multiplied, in step 14, by a quotient. In the preferred case, the quotient is made up of the quotient of the amplitude difference without trailer and the amplitude difference with trailer. The count status is accordingly reduced upon multiplication by said quotient.

After step 14, polling step 23 is carried out. Here is where the actual identification occurs as to whether or not a trailering mode exists. In the present case, the existence of a trailering mode is inferred when the count status falls below a predefined limit value.

If the count status falls below a limit value, i.e. if a trailer is hitched on, the trailer roll logic function is correspondingly adapted, e.g. activated, in step 16. In step 17, adaptation of the vehicle dynamics control system, in particular sensitization, is performed selectably.

If non-trailering mode is identified, then the trailer roll logic function and/or the vehicle dynamics control system is likewise adapted in step 24. In particular, a desensitization and/or deactivation of the trailer roll logic function is accomplished in step 24.

As mentioned, the phase shift evaluation according to step 12 of FIG. 2 is explained in detail in FIG. 3. The program sketched in the form of a flow chart in FIG. 2 and FIG. 3 executes, in the preferred embodiment, in the microprocessor associated with control unit 1.

In a method step 18, firstly the difference between the current value of the actual yaw rate signal and the value of the actual yaw rate signal from the last polling cycle is calculated. The difference between the current value of the target yaw rate signal and the value of the target yaw rate signal from the last polling cycle is also calculated in step 18. In a step 19 subsequent thereto, the product of the differences of the actual and target yaw rate signals is ascertained.

If the sign of the differences is positive, then both signals are moving in the same direction. This is classified as an indication that the signals are largely in phase. For this case, a counter is incremented as a step 20. Optionally, in step 19a the counter can be multiplied starting from an initial value. If the product is negative, then in a step 21 the counter is decremented and limited downward, e.g. to the initialization value. Optionally, in step 21 the counter can be multiplied by a forget factor.

In step 22 the growth of the counter is limited to an upper value. This prevents the need for too great a number of counter decrementing steps in order to reach a lower limit and thus be able to affirm, in step 23 according to FIG. 2, the existence of a trailering mode.

After step 22, execution continues with step 13 according to FIG. 2. The amplitude difference is evaluated, and the counter result from the phase shift evaluation in step 14 is modified, in particular multiplied by the aforesaid quotient, on the basis of the amplitude difference evaluation.

What is claimed is:

1. A method for identifying a trailering mode in the context of a towing vehicle, in particular as part of a vehicle dynamics control system having a trailer roll logic function for stabilizing the combination of towing vehicle and trailer,
wherein identification of the trailering mode is accomplished by a comparison of an actual signal characterizing the vehicle state with a corresponding target signal.

2. The method as recited in claim 1,
wherein the actual signal is an actual yaw rate signal and the target signal is a target yaw rate signal; and/or the actual signal is an actual float angle signal and the target signal is a target float angle signal, and/or the actual signal is an actual steering angle signal and the target signal is a target steering angle signal.

3. The method as recited in one of the preceding claims,
wherein the target signal is ascertained on the basis of a reference model having at least one input variable, in particular the steering angle and/or the vehicle speed.

4. The method as recited in one of the preceding claims,
wherein for identification of the trailering mode, the phase shift between the actual signal and the target signal is evaluated.

5. The method as recited in one of the preceding claims,
wherein for identification of the trailering mode, the amplitude difference between the actual signal and the target signal is evaluated.

6. The method as recited in one of claims 4 or 5,
wherein an exceedance of a limit phase shift is classified as trailering mode, in particular by the fact that the count status of a counter is modified.

7. The method as recited in one of claims 5 or 6,
wherein an exceedance of a limit amplitude difference is classified as trailering mode, in particular by the fact that the count status of a counter is modified.

8. The method as recited in one of claims 4 through 7,
wherein a trailering mode is identified when the limit phase shift and/or limit amplitude difference is exceeded over a predefined time span, or when a predefined number of exceedances is detected.

9. The method as recited in one of claims 4 through 8,
wherein evaluation of the phase shift is accomplished by an evaluation of the directional course of the actual signal and of the target signal.

10. The method as recited in claim 9,
wherein evaluation of the phase shift is accomplished by an evaluation of the codirectional and/or contradirectional courses of the actual signal and of the target signal.

11. The method as recited in claim 9,
wherein an actual signal difference is constituted from the instantaneous actual signal and from an actual signal from a previous polling cycle, preferably the last polling cycle; and a product of the actual signal difference and a target signal difference is constituted, the target signal difference being constituted from the instantaneous target signal and from a target signal of a previous polling cycle, preferably the last polling cycle; and a classification as trailering mode is made as a function of the sign of the product.

12. The method as recited in claim 11,
wherein as a function of the sign of the product, a count status of a counter is modified, in particular the count status of a counter is increased with a positive sign, and the count status is reduced with a negative sign.

13. The method as recited in claim 12,
wherein the maximum and/or minimum count status is limited.

14. The method as recited in one of claims 12 or 13,
wherein the count status is modified as a function of the result of the evaluation of the amplitude difference between the actual signal and the target signal, in particular the count status is reduced upon exceedance of the limit amplitude difference.

15. The method as recited in claim 14,
wherein the count status is multiplied by a quotient of the amplitude difference without a trailer and the amplitude difference with a trailer, or by a reciprocal quotient.

16. The method as recited in one of claims 12 through 15,
wherein a trailering mode is identified when a limit count status is reached.

17. The method as recited in one of the preceding claims,
wherein upon identification of a non-trailering mode, a trailer roll logic function of a vehicle dynamics control system is, preferably temporarily, switched off or desensitized.

18. The method as recited in one of the preceding claims,
wherein when trailering operation has been identified, the behavior of a vehicle dynamics control system is modified, in particular an activation of vehicle stabilization interventions, preferably of vehicle stabilization interventions for the purpose of decreasing the instabilities occurring especially in trailering mode, is accomplished.

19. The method as recited in one of the preceding claims,
wherein when non-trailering mode has been identified, the behavior of a vehicle dynamics control system is modified, in particular a deactivation or attenuation of vehicle stabilization interventions, preferably of vehicle stabilization interventions for the purpose of decreasing the instabilities occurring especially in trailering mode, is accomplished.

20. The method as recited in one of claims 18 or 19,
wherein a modification of the behavior of the vehicle dynamics control system is also accomplished for the case in which the towing vehicle is excited to oscillate even though no driver stipulation to bring the vehicle into a different vehicle state exists.

21. The method as recited in one of claims 4 through 19,
wherein authorization for evaluation of the phase shift between the actual signal and target signal is linked to at least one condition; and preferably, identification of the phase shift remains activated for a parameterizable time span after violation of the condition.

22. The method as recited in one of claims 4 through 20,
wherein upon deactivation of the evaluation of the phase shift between the actual signal and target signal, the variables used, in particular a count status, are reset.

23. A control device for carrying out the method according to one of the preceding claims.

24. A method for identifying a phase shift between a first and a second signal,
wherein identification of the phase shift is accomplished by an evaluation of the codirectional and/or counterdirectional courses of the actual signal and of the target signal.

25. The method as recited in claim 24,
wherein a first signal difference is constituted from a subsequent, preferably current, first signal and from a first signal of a previous polling cycle, preferably of the last polling cycle; and a product of the first signal difference and a second signal difference is constituted, the second signal difference being constituted from the subsequent, preferably current, second signal and from a second signal of a previous polling cycle, preferably the last polling cycle; and an identification of a phase shift is made as a function of the sign of the product.

26. The method as recited in claim 25,
wherein with a negative sign, a phase shift is identified.
